(19) United States
(12) Patent Application Publication
(10) Pub. No.: US 2017/0255903 A1
(43) Pub. Date: Sep. 7, 2017

(54) DETERMINING DELIVERY DATES FOR MULTIPLE PRODUCT TYPES

(71) Applicant: Dell Software, Inc., Round Rock, TX (US)

(72) Inventors: Amer J. Chowdhry, Austin, TX (US); Aravind Rajagopal Kotikanyadanam, Mysore (IN); Anuj Kumar Gupta, Bangalore (IN); K V Sai Prasad, Hyderabad (IN); SivaKumar Sambandam, Banglore (IN)

(21) Appl. No.: 15/060,913

(22) Filed: Mar. 4, 2016

(51) Int. Cl. G06Q 10/08

(52) U.S. Cl. CPC G06Q 10/0833

(57) ABSTRACT

Systems and techniques to determine, substantially in real time, an estimated ship date or an estimated delivery date associated with a product are described. A commitment engine may receive, from a computing device, data associated with a product that comprises a built-to-order product. The commitment engine may determine whether the product is eligible for one of direct shipment, international parcel direct, or hard merge shipment. The commitment engine may determine a shipping method for the product, determine the estimated ship date, the estimated delivery date or both, and send a message to the computing device information identifying at least one of the estimated ship date or the estimated delivery date.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A company that offers products for acquisition to consumers and to businesses (e.g., enterprises) may offer a variety of products, including built-to-order (BTO) and build-to-stock (BTS) product. For a BTO product, a customer may customize the product by specifying which hardware and software components to use etc. A BTS product may be manufactured and stored in inventory, e.g., at a regional warehouse or at a retailer, and may be provided to a customer when the customer places an order. Because of the various logistics involved in BTO and BT products, the company may be unable to provide an accurate delivery date to a customer (or a sales representative) when the customer (or the sales representative) places an order.

### SUMMARY

This Summary provides a simplified form of concepts that are further described below in the Detailed Description. This Summary is not intended to identify key or essential features and should therefore not be used for determining or limiting the scope of the claimed subject matter.

Systems and techniques to determine, substantially in real time, at least one of an estimated ship date or an estimated delivery date associated with a product are described. A commitment agent may receive, from a computing device, data associated with a product that comprises a built-to-order product. The commitment engine may determine whether the product is eligible for one of direct shipment, international parcel direct, or hard merge shipment. The commitment engine may determine a shipping method for the product, determine the estimated ship date, the estimated delivery date or both, and send a message to the computing device information identifying at least one of the estimated ship date or the estimated delivery date.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram illustrating an architecture to provide order fulfillment information according to some examples.

FIG. 2 is a block diagram illustrating an architecture to determine regional data according to some examples.

FIG. 3 is a block diagram illustrating an architecture to determine estimated delivery dates according to some examples.

FIG. 4 is a block diagram illustrating an architecture that includes a lead time calculator according to some examples.

FIG. 5 is a block diagram illustrating an architecture that includes a cart service according to some examples.

FIG. 6 is a block diagram illustrating an architecture that includes a time to shuttle according to some examples.

FIG. 7 is a flowchart of a process that includes determining and providing an estimated ship date (ESD) according to some examples.

FIG. 8 is a flowchart of a process that includes determining and providing an estimated delivery date (EDD) according to some examples.

FIG. 9 is a flowchart of a process that includes determining whether a product is built to order (BTO) or built to ship (BTS) according to some examples.

FIG. 10 illustrates an example configuration of a computing device that can be used to implement the systems and techniques described herein.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

Systems and techniques are described herein for a delivery promise engine to monitor in real-time and provide product commitment dates. The product commitment dates may include exact dates for stocked products (e.g., BTS) and date ranges for built to order (BTO) products. The product commitment dates may be provided to customers that view inventory and enter purchases online and to sales representatives who use sales tools. The product commitment dates may be determined based on inventory data, manufacturing type (stock/non-stocked), supply chain data, add-on services, holidays, and customer-selected delivery options. The system and techniques may be capable of determining product commitment dates for a company, such as Dell®, that has multiple product lines with different types of products (fixed configurations (BTS), built on demand (BTO), and provided by third parties) produced by different original equipment manufacturers (OEMs) and stocked at multiple locations (e.g., distribution centers, warehouses, retailers, etc.) across the world. In addition, system and techniques can take into account changes due to changing business needs, such as changes in OEMs, changes in locations where products are stocked, etc.

### Single Inventory Pool View

The systems and techniques may provide a single inventory view of multiple types of products (e.g., BTO, BTS, etc.), including consolidated views for each type of product. For example, inventories of BTS products at different locations may be consolidated to provide a single inventory pool for regions (e.g., North American region, South American region, Europe region, Asia region, etc.). As products are sold, the systems and techniques may count down inventory levels in approximately real-time to provide an accurate inventory view across multiple sales systems. When a particular product goes out of stock, the system may automatically switch to providing extended lead-times. When the particular product is re-stocked, the system may automatically (e.g., without human interaction) resume using a standard lead-time, thereby providing accurate commitments to customers without involving human oversight.

The systems and techniques may automatically countdown delays. For example, a user (e.g., a supply-demand planner) may add additional time (e.g., additional number of days) when an item is not in inventory to reflect the time for the item to be manufactured. The systems and techniques may automatically decrease (e.g., countdown) the delay on a daily basis until the item is stocked in inventory (e.g., available to ship to the customer). In contrast, in a convention system, a human may check the inbound stock daily and manually adjust the delay every day.

The systems and techniques may automatically adjust lead-times for products manufactured on demand (e.g., BTO). For example, for a product manufactured on demand, availability is generally considered unlimited until the product reaches end-of-life (EOL). However, the lead-times to deliver a BTO product may change based on real-time events through the supply chain (from manufacture to when the product is delivered). For example, a component used to build the product may be delayed, e.g., due to weather, labor unrest, or the like, resulting in a temporary increase in lead time.

The systems and techniques may take into account direct shipment to customer or shipment from a stocking location (e.g., regional warehouse). When a customer is configuring a product using an online shopping interface, the system may automatically determine in approximately real-time (e.g., based on the components the customer is selecting to configure the product) whether the product is available for direct shipment to the customer or whether to route the order to a stocking location. For example, the stocking location may add customization or accessories (e.g., larger capacity battery, software, etc.) that the customer is purchasing with the product. Such real-time determinations provide the customer with an excellent purchase experience by determining how to provide the customer with the shortest available delivery time and accurate delivery expectations.

The systems and techniques may enable planned events and unplanned events to be taken into account when determining delivery times. Planned events may include shutdowns due to holidays (e.g., Golden Week in China), high order volume time periods (e.g., the time period between Black Friday and Christmas in the United States), and other scheduled or known events. Unplanned events may include labor problems (e.g., strike at a port or manufacturing facility), natural disasters (e.g., hurricanes or tsunami) at a component manufacturer, etc. The system includes a special events management component to enable automatic adjustments for events to be made to lead-times provided to consumers or sales representatives that are making purchases. For example, if a tsunami in an Asian country causes manufacturing of a particular hard drive to be delayed, products that are built on demand using that particular hard drive may be updated to reflect an extension in shipping dates for the products.

A rules engine may determine lead-times for individual components (e.g., used in a BTO product). For example, the system may determine lead-times and availability for individual components (e.g., memory, hard drive, processor, etc.) used to build a product. Based on the lead-times and availability, the system may compute shipping dates and delivery dates. If the system determine that a component has become delayed at a manufacturer then the system may automatically (e.g., without human interaction) add the delay to the shipping dates and delivery dates. The system may use machine learning to identify those components that typical (e.g., a high percentage of the time) cause delays, learn what the typical delay time comprises, and automatically count down based on the delay time. For example, the system may, using machine learning, determine that a particular hard drive manufacturer is delayed by two days under a certain set of conditions, e.g., an order for a particular hard drive exceeds a threshold amount. In this example, the system may determine when the set of conditions have been satisfied, automatically add a two day delay, and count down the delay to take into account when the particular hard drive will become available.

The systems and techniques may perform real-time selection of a source (e.g., stocking location) based on the destination. For example, during the buying process the system may automatically select a closest (e.g., in terms of distance) stocking location based on a customer's postal code (e.g., zip code). If the product is not in stock at the closest location, the system may automatically switch from the closest location to a next closest location to enable the sales systems (e.g., including orders received via the interne, via a call center, etc.) to continue taking orders while providing accurate shipping dates and accurate delivery expectations.

The systems and techniques may sell off “safety” stock when a product line is discontinued (e.g., end-of-life). Safety stock (also called buffer stock) is a term used to describe a level of stock that is maintained to reduce the risk of running out of stock of a particular product due to uncertainties in supply (e.g., supply chain) and demand (e.g., unexpectedly heavy demand). When end of life on a product is initiated (e.g., the product is scheduled to be discontinued), the system may begin counting down until the last unit, e.g., including safety stock, is sold. By selling through safety stock for a product for which end of life has been initiated, the manufacturer may avoid selling products that were remaining in safety stock at reduced prices in an outlet store, thereby increasing profits. In a conventional system, products that were remaining in safety stock when the product was discontinued end up being sold at a loss (or for very little profit) at outlet stores.

The system may use machine learning to add, subtract, or modify one or more adders. The system may enable an authorized user to add, subtract, or modify the adders. An adder instructs the system to take into account a delay caused by a particular type of event. The system's rules engine uses an algorithm designed to take into account changing supply chain needs by using adders. For example, adders enable components with a lead time to be added or removed from shipping date calculations and delivery date calculations. For example, a customer may request that a particular product, such as a laptop, be customized. In response, a manufacturer may determine to customize the laptops in Malaysia after they have been manufactured in China. The system may use machine learning to determine how much time is taken to divert the laptops to Malaysia and how long the customization process takes. When an order is received requesting customization, the system may determine that customizing the laptops in Malaysia after they have been manufactured in China is the most efficient means of performing the customization. The system may automatically add a “customize in Malaysia” adder to enable the estimated shipping dates and estimated delivery dates to take into account the delay caused to customize the laptops in Malaysia.

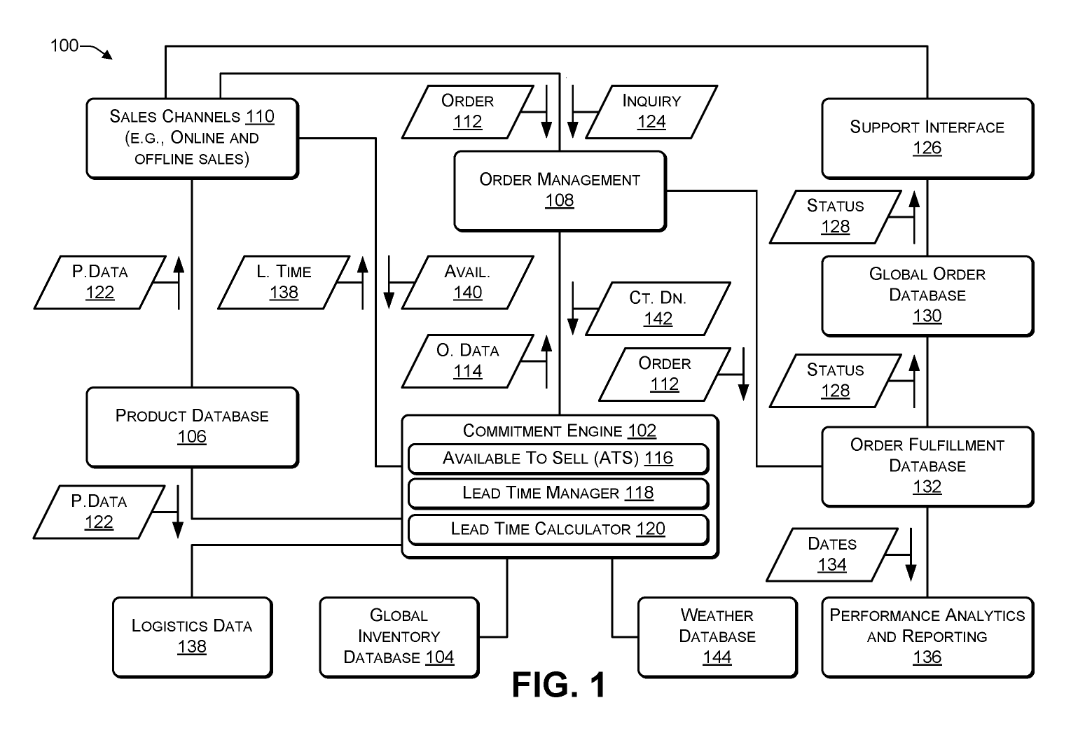

FIG. 1 is a block diagram illustrating an architecture 100 to provide order fulfillment information according to some examples. It should be understood that in a typical implementation, the various components described herein may communicate with each other using one (or more) networks, including wired and wireless networks.

The architecture 100 may include a commitment engine 102 in communication with a global inventory database 104, a product database 106, and an order management module 108. The order management module 108 may enable orders to be received and previously received orders to be cancelled. A buyer (e.g., a consumer, a retailer, etc.) may use one of sales channels 110 (e.g., online sales, offline sales, etc.) to place an order 112. The order 112 may be sent to the order management module 108. The commitment engine 102 may receive the order 112 from the order management module 108 and check the global inventory database 104 to determine if the product is available for ordering. In some cases, the commitment engine 102 may retrieve product data 112 from the product database 106. The commitment engine 102 may provide order data 114, such as, for example, an estimated shipping date (ESD), an estimated delivery date (EDD), other order-related information, or any combination thereof, to the order management module 108. The order management module 108 may provide the order data 114 to the buyer via one of the sales channels 110. For build-to stock (BTS) products in the order 112 that are not in stock and for products in the order 112 that are build-to-order (BTO), the commitment engine 102 may determine the ESD and EDD using a lead time manager 118. The lead time manager 118 may use a lead time calculator 120 to determine the lead time for the products to become available or to be built.

For the product(s) in the order 110 that are BTS, the commitment engine 102 may check availability using an available to sell (ATS) database 116. For products(s) in the order 110 that are BTO (or that are BTS but not currently in stock), the commitment engine 102 may determine a lead time to build the product(s) using the lead time manager 118 and the lead time calculator 120. For example, the lead time manager 118 may determine product data 122 (e.g., including information about the parts used to build the product) associated with a particular product from the product database 106, determine the lead time for the parts used to build the product, and calculate (e.g., using the lead time calculator) the lead time to build the product.

A buyer may, after submitting the order 112, use one of the sales channel 110 to submit an inquiry 124 associated with the order 112 to the order management module 108. For example, the inquiry 124 may request an ESD, an EDD, or both associated with one or more products included in the order 112. In response to receiving the inquiry 124 via the order management module 108, the commitment engine 102 may determine the availability using the ATS database 116 or determine the lead time using the lead time manager 118 and provide the order data 114.

The sales channels 110 may communicate with a support interface 126 to connect customers with support staff via email, chat (e.g., messaging, such as instant messaging), phone call (e.g., to a call center), or other support mechanism. Support staff may use the support interface 126 to determine status information 128 from a global order database 130. The global order database 130 may determine the status information 128 associated with an order (e.g., the order 112) from an order fulfillment database 132 that keeps track of the status of orders, e.g., which orders have been fulfilled, which orders are in the process of being fulfilled, etc. The order fulfillment database 132 may provide dates 134 to a performance analytics and reporting module 136. The dates may include ship dates associated with orders, delivery dates associated with orders, dates when an exception occurs (e.g., business closed, no one available to sign for an order delivery, incorrect address, etc.), and other order-related dates. The performance analytics and reporting module 136 may be part of enterprise business intelligence (EBI) of an enterprise (e.g., company) that is selling products via the sales channels 110. The commitment engine 102 may access logistics data 138. The logistics data 138 may include relatively current (e.g., updated within the past few hours) logistics information received from carriers (e.g., USPS®, UPS®, FedEx®, DHL®, and the like) as to how long shipments are taking between different locations, whether any major events (e.g., inclement weather, transport vehicle malfunction, etc.) have occurred to cause delays in shipments in particular routes, etc. The logistics data 138 may include costs associated with the various modes of delivery (e.g., same day delivery, next day delivery, N day delivery, lowest cost delivery, etc.) for each carrier. The logistics data 138 may include historical logistics information associated with fulfillment centers. For example, in some cases, a first fulfillment center may be closer (e.g., distance-wise) to a particular region that a second fulfillment center. However, orders from the particular region may historically be fulfilled faster when the second fulfillment center is used rather than the first fulfillment center. For example, carriers may have easier access to the second fulfillment center than the first fulfillment center, e.g., an airport may be much closer to the second fulfillment center, traffic near the second fulfillment center may be less, the roads near the second fulfillment center may permit faster speeds, the second fulfillment center may have faster loading equipment, etc. The logistics data 138 may thus enable the commitment engine 102 to select a carrier and a delivery mode that provides the fastest delivery at the lowest cost taking into account the type of delivery that the customer has requested.

Before a customer places an order (e.g., the order 112) via one of the sales channels 110, the commitment engine 102 may provide, substantially in real-time, lead time data 138 to enable the customer to determine whether the lead time satisfies the customer's needs. For example, a customer may use an online configurator (e.g., one of the sales channels 110) to create a BTO product and determine (e.g., using the lead time data 138 provided by the commitment engine 102) that the lead time to deliver the product is one week. The customer may determine, using an online website (e.g., that displays the lead time data 138 provided by the commitment engine 102), that a BTS product is in stock and the lead time to deliver the product is zero. If the customer desires to use the product in less than a week, then the customer may opt to order the BTS product. If the customer is able to wait for at least a week, then the customer may opt to order the BTS product. As another example, the customer may be provided the lead time data 138 for two BTO products, such as two configurations of a computer. The first configuration, including an Intel® i7 processor, may have a two week lead time while the second configuration, with an Intel i5 processor, may have a one week lead time. Based on the lead time data 138 provided via one of the sales channels 110 (e.g., online, from a sales person, etc.), the customer may decide whether to get the i5 processor or wait an extra week to get the computer with the i7 processor.

The sales channels 110 may perform an availability check 140, e.g., an available to promise (ATP) check, for a particular product. In response to receiving the availability check 140, the commitment engine 102 may determine whether the requested delivery quantity can be provided by a requested delivery date. The commitment engine 102 may take into account pre-delivery activities, such as scheduling for picking (e.g., components or products), packing time, and the time taken to produce or obtain the components or products.

The order management module 108 (or another module) may send a countdown message 142 requesting that the commitment engine 102 count down the inventory of one or more products. For example, the countdown message 142 may be sent when a product is discontinued (e.g., end-of-life is initiated). In response to receiving the countdown message 142, the commitment engine 102 may sell off “safety” stock to maximize profits (e.g., for the seller or manufacturer) on the remaining stock.

The order fulfillment database 132 may periodically receive (e.g., hourly, daily, etc.) or may download the order 112 received by the order management module 108. The order 112 received or downloaded from the order management module 108 may be used to update the order fulfillment database 132 to enable the order to be fulfilled.

When determining lead times (e.g., the lead time 138), the commitment engine 102 may automatically take weather information into consideration based on weather data provided by a weather database 144. The commitment engine 102 may determine weather data for a particular region from the weather database 144 before determining a lead time. For example, if a BTS product is to be shipped from a regional warehouse, the commitment engine 102 may determine the weather in the vicinity of the regional warehouse when determining the lead time. As another example, if a BTO product is to be shipped from a first country to a second country, the commitment engine 102 may determine the most likely route that the shipment will use and determine the weather along the likely route when determining the lead time. If the BTO product uses components manufactured in an area that is prone to seasonally adverse weather (e.g., snow storms, monsoon or heavy rains, etc.) then the commitment engine 102 may determine the weather forecast for the area when determining the lead time. The commitment engine 102 may also receive alerts from the weather database 144 regarding sudden weather changes (e.g., tornado, hurricane, tropical storm, etc.). For example, an alert may identify that a hurricane is heading towards a particular region, causing the commitment engine to increase lead times for products (or components) being shipped to or shipped from the particular region. A subsequent alert may downgrade the hurricane to a tropical storm, causing the commitment engine to adjust (e.g., decrease) the lead times.

Thus, a commitment engine may enable different sales channels, including online shopping sites, call centers with sales people, staff at retail or wholesale stores, staff at distributors, and the like, to view substantially in real time lead times for different types of products. The different types of products may include BTS products that are stocked in regional warehouses and BTO products that are built based on user-specified parts. The commitment engine may enable customers and sales staff to view, via a browser and substantially in real time, the status of an order (e.g., including BTS and BTO products). For example, a customer or sales person may use an online catalog to select or configure a product (e.g., using an online browser). When a BTS product is selected or a BTO product is configured, the online catalog may send a query to the commitment engine 102 to determine the ESD, the EDD, or both, associated with the product. The commitment engine 102 may determine the ESD and/or EDD and send a message to the browser, substantially in real time, indicating the ESD and/or EDD. The customer may compare different products and select one of the products based in part on each product's ESD and/or EDD. Substantially in real time indicates that the commitment engine 102 may determine the ESD and/or EDD typically within a few milliseconds such that the time between the browser displaying the online catalog ending the query to the commitment engine 102 and the browser receiving the ESD/EDD from the commitment engine 102 is less than 30 seconds.

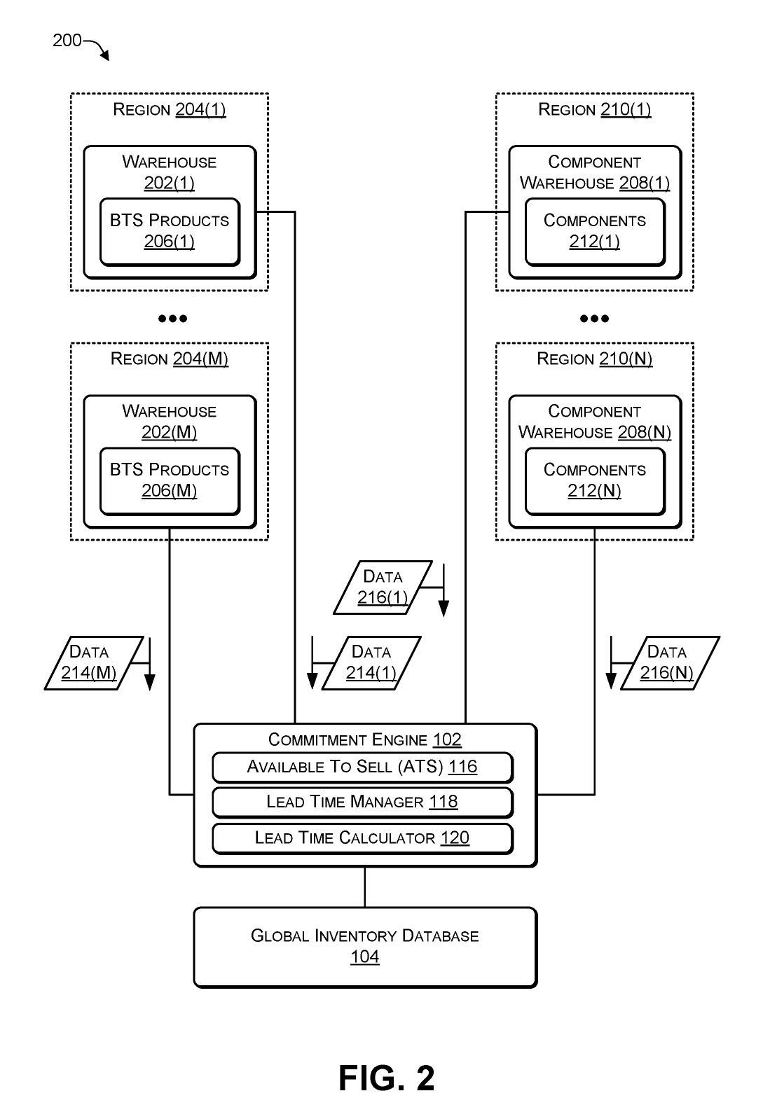

FIG. 2 is a block diagram illustrating an architecture 200 to determine regional data according to some examples. The architecture 200 includes a warehouse 202(1) located in a region 204(1). The warehouse 202(1) may stock a set of (e.g., one or more) BTS products 206(1). The architecture 200 includes a warehouse 202(M) (where M>0) located in a region 204(M) and stocking a set of BTS products 206(M). For example, the BTS products 206(1) to 206(M) may include computers (e.g., laptops, desktops, tablets, etc.), computer accessories (e.g., monitors, docking stations, etc.), and other technology-related products.

The architecture 200 may include a component warehouse 208(1) located in a region 210(1) and stocking a set of components 212(1) and a component warehouse 208(N) (where N>0, N not necessarily equal to M) located in a region 210(N) and stocking a set of components 212(N). For example, the components 212 may include parts used to assemble items, such as computers, computer accessories, and the like. To illustrate, for BTO computers, the components 212 may include disk drives, processors, memory devices, display screens, optical drives, keyboards, cases, etc.

Individual regions of the regions 204, 210 may span two or more countries, e.g., a North American region may include Canada, the United States, and Mexico. The individual regions of the regions 204, 210 may be within a country, e.g., the United States may include an east coast region, a west coast region, a south-east region, a south-west region, a mid-west region, etc. At least one of the regions 210 may be different from one of the regions 204, e.g., at least some of the regions 204 may be different from some of the regions 210.

The commitment engine 102 may periodically (e.g., at pre-determined intervals) receive (or retrieve) data from each of the warehouses 202 and 208 in the regions 204 and 210, respectively. For example, the commitment engine 102 may receive (or retrieve) data 214(1) from the warehouse 202(1) and receive (or retrieve) data 214(M) from the warehouse 202(M). The commitment engine 102 may receive (or retrieve) data 216(1) from the component warehouse 208(1) and receive (or retrieve) data 216(N) from the component warehouse 208(N). The data 214 may include updated (e.g., current) inventory information associated with the BTS products 206. The data 216 may include updated (e.g., current) inventory information associated with the components 212. For example, the data 214 or 216 may indicate that a shipment of a BTS product or a shipment of a component has been received or has been delayed (e.g., due to weather, materials shortage, etc.).

Based on the data 214, the commitment engine 102 may update lead times associated with the corresponding BTS product(s) in the global inventory database 104. based on the data 216, the commitment engine 102 may update lead times associated with the corresponding BTO product(s) in the global inventory database 104.

Thus, a commitment engine may receive (or retrieve) updates from regional warehouses that stock BTS products and from regional warehouses that stock components used to create BTO products. The commitment engine may update lead times associated with the BTS products and the BTO products in a global inventory database based on the updates. The commitment engine may retrieve information from a regional warehouse in response to the commitment engine receiving a query regarding an ordered item.

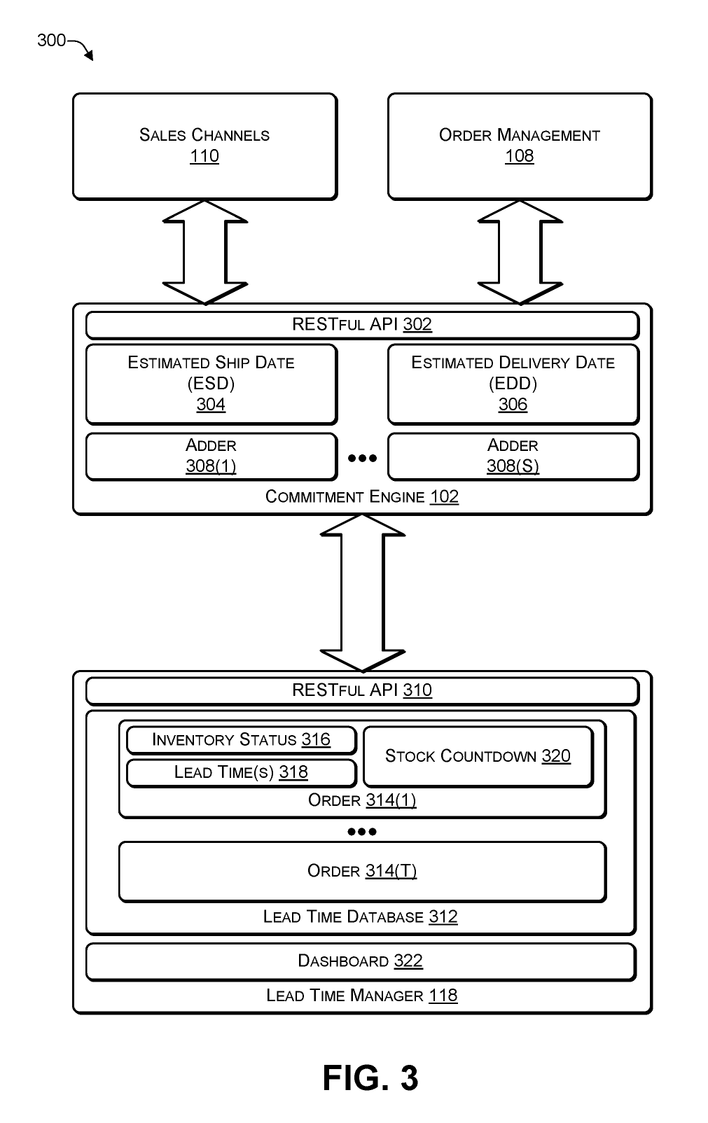

FIG. 3 is a block diagram illustrating an architecture 300 to determine estimated delivery dates according to some examples. The sales channels 110 and the order management module 108 may interact with the commitment engine 102 using an interface, such as a representational state transfer (REST)ful application programming interface (API) 302. For example, the sales channels 110 and the order management module 108 may use the RESTful API 302 to determine information associated with an order, such as an estimated ship date (ESD) 304 of an order, an estimated delivery date (EDD) of an order, or both, from the commitment engine 102. The commitment engine 102 may include multiple adders, such as an adder 308(1) to an adder 308(S) (where S>0). Zero or more of the adders 308 may be added to each order to modify the lead time associated with the order or with a product in the order. For example, the adders 308 may include a custom fulfillment service (CFS) adders that is used with BTO products to customize the product based on a customer request. The CFS adder may be used to adjust (e.g., add to) a lead time associated with customizing a BTO product according to specifications provided by the customer. The adders 308 may include a planned event adder that takes into account planned events, such as government holidays, plant shutdowns for planned repairs or upgrades, and other types of events that are known in advance. The adders 308 may include an unplanned event adder that takes into account unplanned events, such as delays caused by weather (e.g., hurricane, tornado, tsunami, etc.), delays caused by labor strife (e.g., strike by workers), and other types of unplanned events. The adders 308 may include a large item adder that takes into account the special handling associated with bulky items, fragile items, and other types of items (e.g., televisions with a size of 42″ or greater), that require special handling during transportation, delivery, or both. The adders 308 may include an order size adder may be used to take into account special handling associated with large orders (e.g., large palette, etc.). The systems and techniques described herein may enable many different types of adders to be created in addition to the examples provided. The commitment engine 102 may use machine learning to determine an amount of lead time to use for each type of adder, based on the type of order (e.g., BTS product or BTO product), the region(s) associated with an order (e.g., the regions in the shipping route associated with each product in an order). For example, the commitment engine 102 may use machine learning to determine that even though the Thanksgiving holiday in the United States is a single day, companies (including shipping companies) shut down for the Thursday and Friday (e.g., the Friday immediately after Thanksgiving), resulting in Thanksgiving adding at least two additional days to the lead time.

The commitment engine 102 may interact with the lead time manager 118 using an interface, such as a RESTful API 308. For example, the commitment engine 102 may use the RESTful API 308 to determine or update order information stored in a lead time database 312, such as, for example, information associated with orders 314(1) to 314(T) (T>0). To illustrate, the commitment engine 102 may use the RESTful API 308 to determine or update (i) an inventory status 316 of BTS products (or BTO components associated with products) in the order 314(1), (ii) one or more lead times 318 of BTS products (or BTO components associated with products) in the order 314(1), (iii) a stock countdown 320 for BTS products scheduled to be discontinued that are included in the order 314(1), other order-related information associated with the order 314(1), or any combination thereof

The lead time manager 118 may provide a dashboard 322 with information associated with the orders 314, such as the most current ESD and EDD for each order (or each product in an order), etc.

To determine the ESD 304 for a BTO order, the commitment engine 102 may determine (i) product details associated with a product in an order, (ii) a manufacturing lead time associated with the product, (iii) a payment lead time (e.g., the time between when a supplier is paid and a product or component is provided), (iv) adders, including a planned event adder (e.g., for holidays, etc.), a CFS adder, other factors affecting the ship date, or any combination thereof. To determine the EDD 306 for a BTS order, the commitment engine 102 may determine (i) a fulfillment location associated with the BTS product, (ii) a logistics lead time based on a postal code of the fulfillment location to a postal code of the destination location, (iv) adders, including a planned event adder (e.g., for holidays, etc.), a large/bulky item adder, other factors affecting the ship date, or any combination thereof

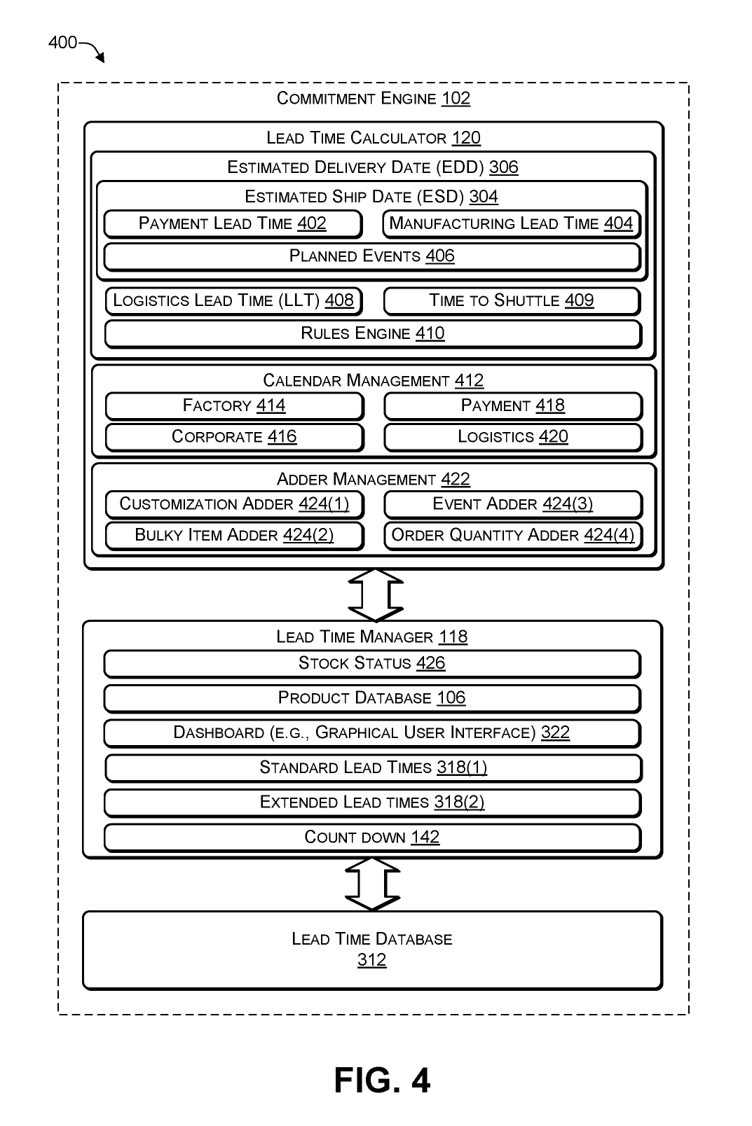

FIG. 4 is a block diagram illustrating an architecture 400 that includes a lead time calculator according to some examples. The lead time calculator 120 may determine the ESD 304 based on a payment lead time 402, a manufacturing lead time 404, planned events 406, another factor related to the ship date, or any combination thereof. The payment lead time 402 may specify a time period between when payment is to be made to a manufacturer and when the product is ready to be shipped. The manufacturing lead time 404 may specify the time period between the placement of an order and the shipment of the completed order. The planned events 406 may include events that are known in advance, such as holidays, plant shutdowns for scheduled maintenance, and other events that have been scheduled and that may affect the ESD 304.

The lead time calculator 120 may determine the EDD 306 based on the ESD 304, a logistics lead time (LLT) 408, a time to shuttle (e.g., shuttle lead time) 409, and a rules engine 410. The LLT 408 identifies the time period between when an order is placed and when the order is fulfilled (e.g., typically when the order is delivered). The LLT 408 may include procurement (e.g., obtaining inventory of parts used in a product prior to starting production), production (e.g., manufacture, assembly, quality control, such as testing, etc.), and distribution (e.g., allocation, assignment, and tracking of shipment and delivery resources, etc.). The time to shuttle 409 may indicate the shuttle lead time, e.g., the time to shuttle (e.g., transport) a manufactured product from the manufacturing facility to a fulfillment center (e.g., one of the warehouses 202 or 208 of FIG. 2). The rules engine 410 may include various rules to determine the EDD 306. For example, the rules engine 410 may determine whether a product is a BTS product or a BTO product. For a BTS product, the rules engine 410 may determine the time to ship the BTS product from a fulfilment center to the customer's location (e.g., to the customer's postal code).

For a BTO product, the rules engine 410 may determine whether the BTO product is direct ship eligible, e.g., shipped from an Original Design Manufacturer (ODM) to a carrier hub and then to the delivery location (e.g., postal code). The carrier may include a postal service (e.g., United States Postal Service), FedEx, United Parcel Service (UPS), another carrier, or any combination thereof. For a BTO product, the rules engine 410 may determine whether the BTO product is eligible for international parcel direct, e.g., shipped from an ODM directly to the customer's postal code (e.g., USPS zip code). For a BTO product, the rules engine 410 may determine whether the BTO product is eligible for a “hard merge” where the BTO product is shipped from the ODM to a fulfillment center (e.g., regional stocking warehouse) and then from the fulfillment center to the delivery location (e.g., customer's postal code, such as USPS zip code).

For both BTS and BTO products, the rules engine 410 may determine shipping options, such as ground, air, next day, etc. when determining the ESD 304 and EDD 306. The shipping option that is selected for each order (or each product in an order) may include (i) a shipping option selected (and paid for) when the order was placed, (ii) an upgraded shipping option selected (and paid for) after the order was placed but before the order was shipped, (iii) a location from which the assembled product(s) are to be shipped, (iv) the location that the customer has specified where the order is to be delivered, (v) when each product in an order will be ready to ship (e.g., a product should be ready to ship before the carrier's scheduled arrival time—for example, if a carrier picks up at 4:00 PM and the product is not ready on a particular day, then the carrier may pick up the item on the next day), (vi) how long (e.g., how many days) the shipping option takes from pickup to delivery, (vii) other shipping-related factors, or any combination thereof.

For both BTS and BTO products, when determining the ESD 304 or the EDD 306, the rules engine 410 may determine whether the order is to undergo special handling due to a number of items in the order or whether the order includes a bulky product. For example, orders with more than X items (X>0), such as orders with 25 or more products, or an order that includes a product that is considered a bulky item, may undergo special handling, e.g., the order may be shipped using a carrier (e.g., freight carrier) that is capable of handling the quantity, size, or weight of products in the order. To illustrate, orders with 25 or more products or that include a bulky product may be shipped on a pallet (e.g., to enable the order to be moved using a forklift) and may be transported using a freight company. A bulky product may be one that has a packed weight greater than a predetermined threshold, at least one dimension (e.g., height, width, or depth) greater than a predetermined threshold, total dimensions (e.g., height+width+depth) greater than a predetermined threshold, another special handling characteristic, or any combination thereof.

The lead time calculator 120 may determine lead times by managing (and taking into account) various calendars using a calendar management module 412. For example, the calendar management module 412 may manage multiple calendars, including a factory calendar 414 (e.g., to take into account factory holidays, planned shutdowns for maintenance, etc.), a corporate calendar 416 (e.g., a calendar associated with a company that sells BTO and BTS products, such as Dell®), a payment calendar 418 (e.g., identifying when payment is due to various suppliers of BTO and BTS products, including OEM and ODM providers), and a logistics calendar 420 (e.g., identifying when each carrier performs a pickup at each regional warehouse, which holidays each carrier observes, and the like).

The lead time calculator 120 may include an adder management module 422. The adder management module 422 may enable a user to add to an order one or more adders for planned and unplanned events (e.g., worker strike or slowdown, weather condition such as snowstorm, tsunami, etc.). The adder management module 422 may use machine learning to determine when to automatically add one or more adders 424 to an order. The adders may, for example, include a customization adder 424(1), a bulky item adder 424(2), an event (e.g., planned and unplanned event) adder 424(3), and an order quantity adder 424(4). The customization adder 424(1) may be added to increase lead time when an order includes customization, e.g., a BTO or BTS product may be shipped to an intermediate location for customization before being shipped to the customer for delivery. The event adder 424(3) may be used to take into account unplanned events (e.g., hurricane, tsunami, dock workers strike, etc.) and planned events, such as holidays, maintenance shutdowns, etc. The bulky item adder 424(2) may be used to take into account handling for a bulky item, e.g., an item that has a packed weight greater than a predetermined threshold, at least one dimension (e.g., height, width, or depth) when packed that is greater than a predetermined threshold, total dimensions (e.g., height+width+depth) when packed that are greater than a predetermined threshold, another special handling characteristic, or any combination thereof. The order quantity adder 424(4) may be used to take into account orders with more than X items (X>0), such as orders with 25 or more products, that only some carriers may be capable of transporting. Of course, other adders may be defined in addition to those illustrated in FIG. 4.

The lead time manager 118 may determine a lead time for an order (or a product in an order) based on a stock status 426 (e.g., whether a BTS item is in stock), the product database 106, lead times 318 (e.g., include a standard lead time 318(1) and an extended lead time 318(2), and the lead time database 312. The lead time manager 118 may provide the dashboard 322 (e.g., in the form of a GUI) to enable a customer to view the various lead times associated with parts used to create a BTS product, the lead times associated with a BTS product, and the like. The lead time manager 118 may automatically perform the count down 142 of various lead times to display, substantially in real time, data in the dashboard 322. For example, a planned event, such as a New Year celebration in China, may be a fixed number of days in length. The lead time manager 118 may automatically perform the count down 142 of the planned event when displaying the lead time(s) for BTO products that are assembled in China.

Thus, when a customer or sales person views a BTS or BTO product in an online catalog, the lead time calculator 120 may provide the ESD 304, the EDD 306, or both, substantially in real time. By displaying the ESD 304 and/or EDD 306 substantially in real time, the customer or sales person can use the ESD 304 and/or EDD 306 associated with each product to determine which product to purchase. For example, a customer may desire to purchase a product with at least a particular product specification. The customer or sales person may determine whether a BTO product that satisfies the particular product specification but that requires Y days for delivery and costs $Z. In this example, a first BTS product may be cheaper than the BTO product but may not satisfy all of the particular product specifications while a second BTO product may be more expensive than the BTO product but may exceed at least some of them particular product specifications. Both the first and second BTS product may be delivered faster than the BTO product. The lead times displayed in near real time by the lead time calculator 120 may enable the customer or sales person to determine which product (e.g., from the BTO product or the first and second BTS products) to order.

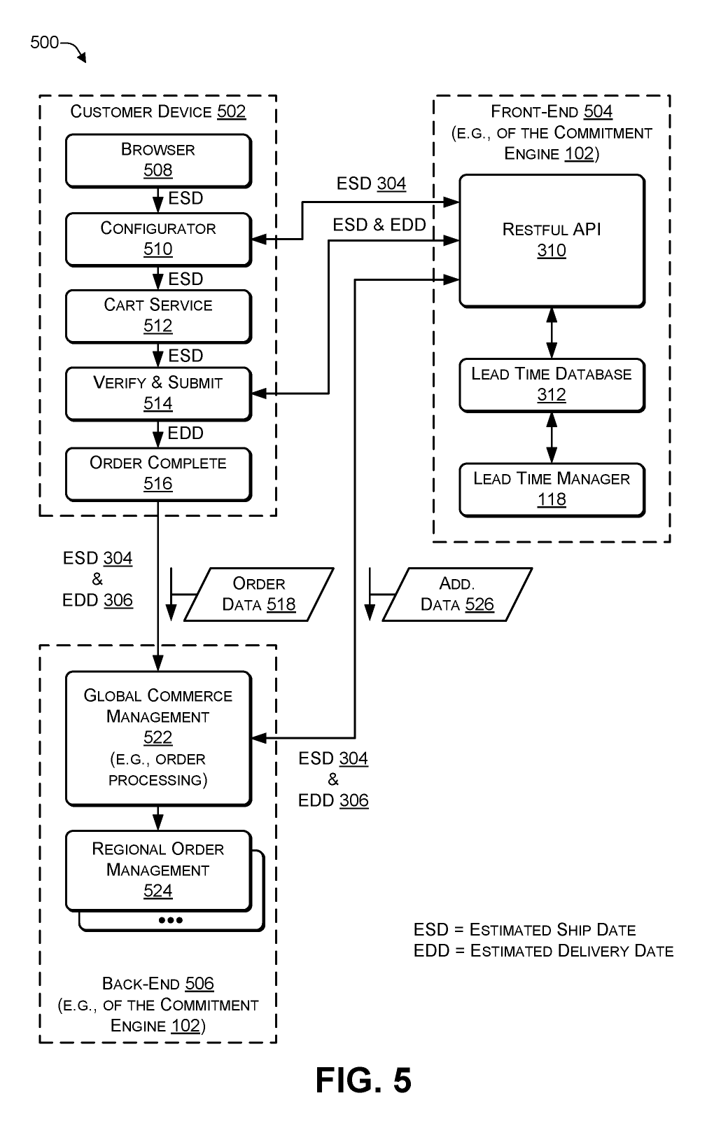

FIG. 5 is a block diagram illustrating an architecture 500 that includes a cart service according to some examples. The architecture 500 includes a customer device 502, a front-end 504 of the commitment engine 102 (of FIGS. 1-3) and a back-end of the commitment engine 102.

The customer device 502 may be a computing device, such as a laptop computer, a desktop computer, or a tablet computer. A customer (or sales person) may use an interne browser 508 to navigate to an online configurator 510 to configure one or more BTO products. The configurator 510 may interact with the RESTful API 310 of the front-end 504 to provide the ESD 304 to the customer (or sales person). The customer (or sales person) may add one or more BTO products (e.g., configured using the configurator 510) to an online shopping cart service 512 and use a verify and submit screen 514 to verify that the order is correct and submit an order for the contents of the online shopping cart. The verify and submit screen 514 may interact with the RESTful API of the front-end 504 to determine and display the ESD 304 and EDD 306 associated with each product in the order. After the customer (or sales person) has submitted the order, the customer device 502 may display an order complete message 516.

The back-end 506 may receive order data 518 from the customer device 502. The order data 518 is provided as input to a global commerce management module 522. In some cases, the global commerce management module 522 may obtain additional order data 526 (e.g., additional data provided by the customer device 502 when the order was submitted during the verify and submit 514) from the RESTful API 310. The global commerce management module 522 may process the order data 518 and send at least a portion of the converted order data 518 to one or more regional order management services 524. The global commerce management module 522 may add the order data 518, such as the ESD 304 and/or the EDD 306, to a schema to provide downstream order processing components the lead time information (e.g., ESD 304 and EDD 306) that was provided to the customer. Thus, the lead times provided to the customer and sent downstream to the regional order management 524 and fulfillment centers (one or more of the warehouses 202 and 208 of FIG. 1). For example, the global commerce management module 522 may determine the closest of the regional order management services 524 to the delivery location specified in the order data 518 or the additional order data 526 and send the order data 518 to the closest regional order management services 524 for fulfillment.

Thus, a customer or sales person may use a browser to launch a configurator to configure a BTO product. After the BTO product has been configured, the customer or sales person may submit an order that includes order information, such as the configuration details, the EDD, the ESD, the delivery location, and the like. When the customer is using the configurator to configure a product, the lead time database may provide near real-time updates of lead times for particular components that the customer selects. The lead time updates may cause the ESD, the EDD, or both to change. For example, if the customer selects a special type of hard drive (e.g., a solid state drive (SSD) instead of a mechanical disk drive), then the lead time database may determine a lead time for the special type of hard drive, causing the ESD and/or EDD to be update based on the lead time. The customer device may interact with a front-end and a back-end of the commitment engine. The commitment engine may receive the order data, parse the order data, and send one or more portions of the order to regional build houses to configure, build, and ship the BTO product(s) to the delivery location specified in the order.

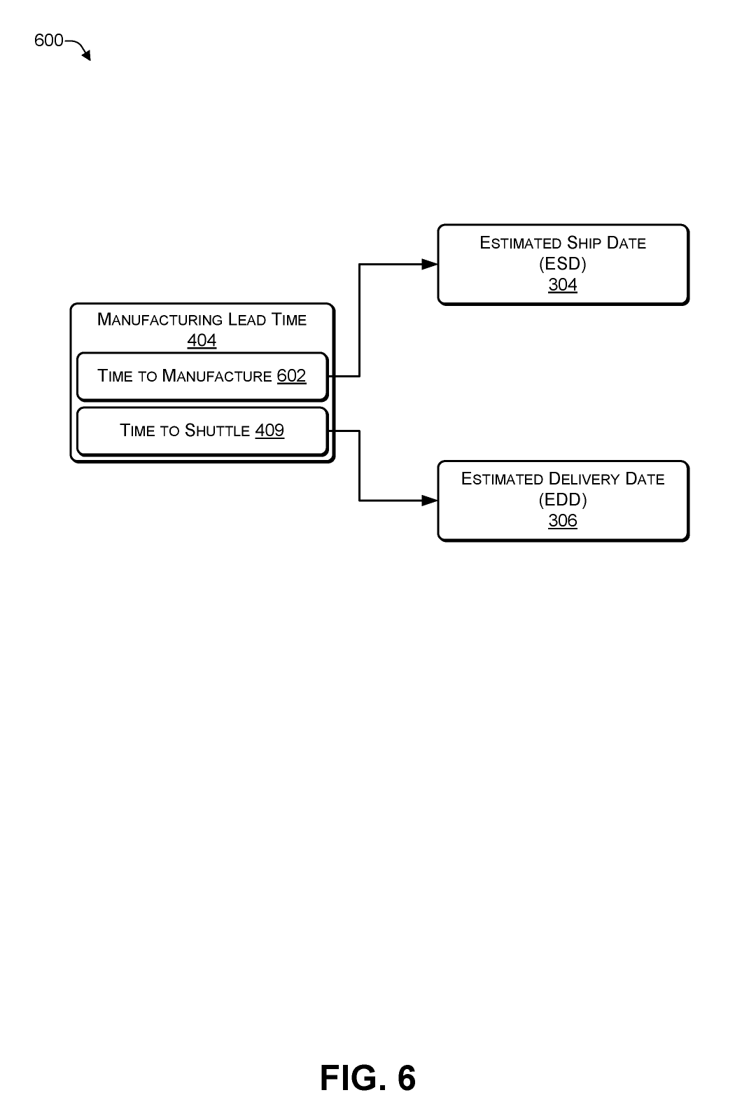

FIG. 6 is a block diagram illustrating an architecture 600 that includes a time to shuttle according to some examples. The manufacturing lead time 404 may include a time to manufacture (a BTS or BTO product) 602 at a manufacturing facility and the time to shuttle 409 the manufactured product from the manufacturing facility to a fulfillment center (e.g., one of the warehouses 202 or 208 of FIG. 2). The time to manufacture 602 may be included when determining the ESD 304. The time to shuttle 409 the manufactured product from the manufacturing facility to the fulfillment center may be included when determining the EDD 306.

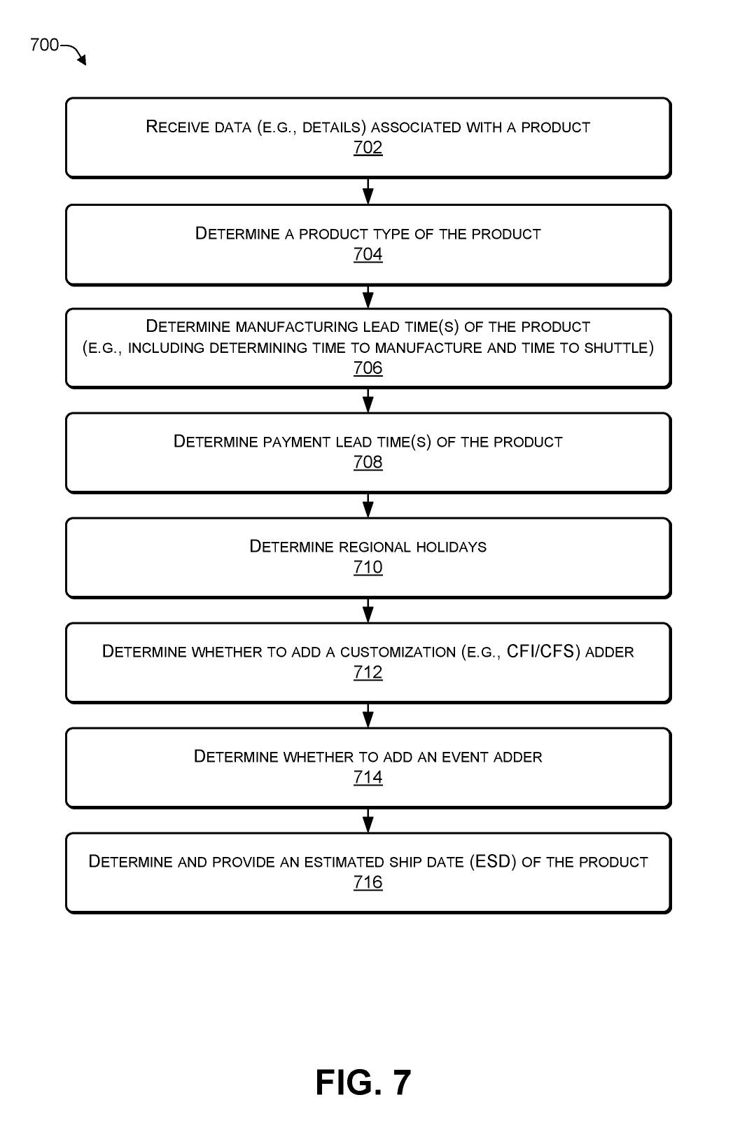

In the flow diagrams of FIGS. 7, 8, and 9, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 700, 800, and 900 are described with reference to FIGS. 1, 2, 3, 4, 5, and 6 as described above, although other models, frameworks, systems and environments may implement these processes.

FIG. 7 is a flowchart of a process 700 that includes determining and providing an estimated ship date (ESD) according to some examples. For example, the process 700 may be performed by one or more components of the commitment engine 102 of FIGS. 1-6.

At 702, details associated with a product (or order) may be received. At 704, a product type associated with the product (or each product in an order) may be determined (e.g., based on the product details). The details may be received when a customer or sales person is viewing the product online prior to placing an order. For example, in FIG. 1, the commitment engine 102 may receive product details, including a type of product that a customer desires to acquire, from a customer device via one of the sales channels 110. The details may be received after a customer or sales person has placed an order, e.g., when the customer or sales person requests an update on the ESD, EDD, or both. The details may be received when an unplanned event occurs and the commitment engine automatically updates the ESD, EDD, or both.

At 706, manufacturing lead times may be determined. At 708, payment lead times may be determined. For example, in FIG. 4, the commitment engine 102 may use the lead time manager 118 to determine various lead times, including the manufacturing lead time 404 and the payment lead time 402. Determining the manufacturing lead time 404 may include determining the time to manufacture 602 and the time to shuttle 604. The time to manufacture 602 may be used to determine the ESD 304. The time to shuttle 604 may be used to determine the EDD 306.

At 710, regional holidays may be determined and taken into account (e.g., to determine the ESD). For example, in FIG. 4, the calendar management 412 may determine regional holidays of a region in which a BTS fulfillment center (e.g., regional warehouse) is located or a BTO manufacturing facility is located.

At 712, a determination may be made whether to add a customization adder (e.g., custom factory integration (CFI) or custom factory service (CFS)). For example, if the order data includes a request for customization, the customization adder 424(1) of FIG. 4 may be added to the lead time determination and the ESD for the product.

At 714, a determination may be made whether to add a planned event adder. For example, if a the calendar management 412 identifies one or more planned events, one or more of the event adder 424(3) of FIG. 4 may be added to the lead time determination and the ESD for the product.

At 716, an estimated ship date (ESD) associated with the product may be determined and provided (e.g., in approximately real time). For example, when the commitment engine 102 receives a message from one of the sales channel 110 indicating a potential order for a product, the commitment engine 102 may perform one or more of 702, 704, 706, 708, 710, 712, or 714 to determine, approximately in real time, the ESD for the product. The commitment engine 102 may provide the ESD to the corresponding sales channel 110 to enable the customer or sales person to select a product with an ESD that satisfies the customer's needs prior to the order being placed. After the order has been placed, the ESD may be determined and provided in response to a customer query. After the order has been placed, the commitment engine may automatically update the ESD (e.g., due to an unplanned event) and notify the customer of the updated ESD.

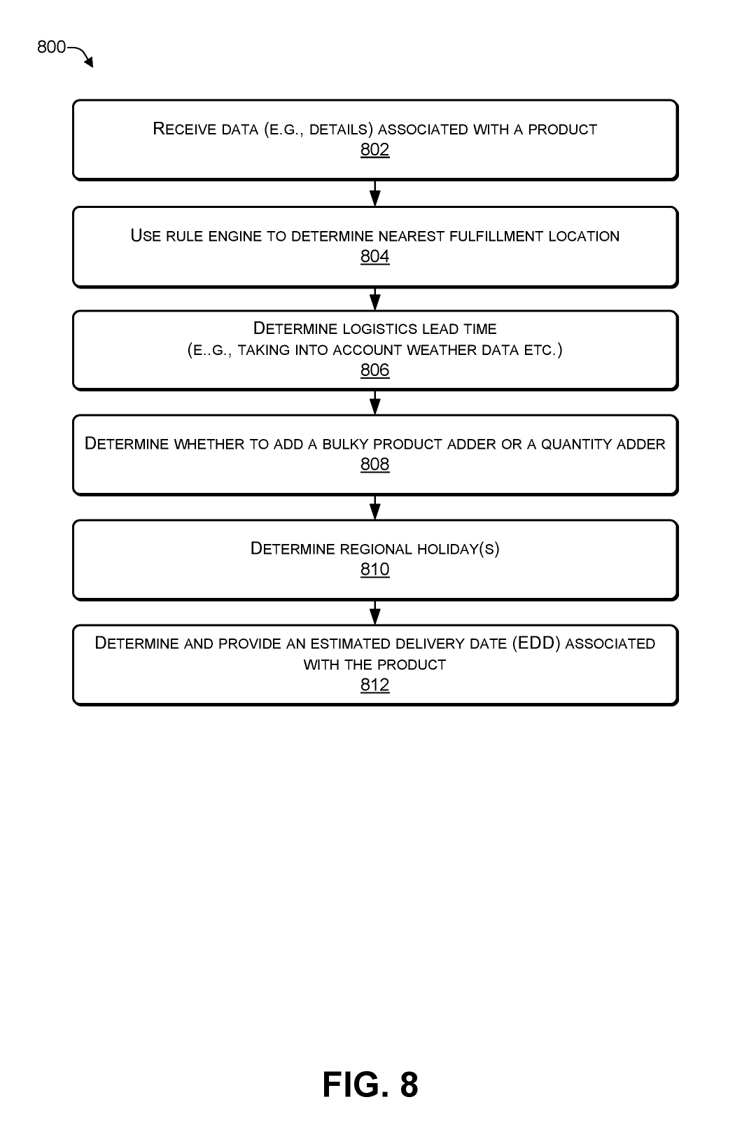

FIG. 8 is a flowchart of a process 800 that includes determining and providing an estimated delivery date (EDD) according to some examples. For example, the process 800 may be performed by one or more components of the commitment engine 102 of FIGS. 1-6.

At 802, details associated with a product (or an order) may be received. The details may be received when a customer or sales person is viewing the product online prior to placing an order. For example, in FIG. 1, the commitment engine 102 may receive product details, including a type of product that a customer desires to acquire, from a customer device via one of the sales channels 110. The details may be received after a customer or sales person has placed an order, e.g., when the customer or sales person requests an update on the ESD, EDD, or both. The details may be received when an unplanned event occurs and the commitment engine automatically updates the ESD, EDD, or both.

At 804, a rule engine may be used to determine a fulfillment location. For example, in FIG. 4, the rules engine 410 may identify a fulfilment location (e.g., BTS warehouse to BTO manufacturer) that is nearest to the delivery location or has the fastest fulfillment taking into account various factors to the delivery location. For example, a first location may be closer to the deliver location than a second location, but the second location may be accessible to a courier than can provide overnight service to the delivery location whereas the none of the couriers can provide overnight service from the first location.

At 806, at least one logistics lead time may be determined. For example, in FIG. 4, the LLT 408 may determine the time period between when an order is placed and when the order is fulfilled (e.g., typically when the order is delivered). The LLT 408 may include procurement (e.g., obtaining inventory of parts used in a product prior to starting production), production (e.g., manufacture, assembly, quality control, such as testing, etc.), and distribution (e.g., allocation, assignment, and tracking of shipment and delivery resources, etc.). The LLT 408 may be determined based on the logistics data 138 as well as current and predicted weather information provided by the weather database 144.

At 808, a determination may be made whether to add a bulky product adder or a quantity adder. For example, in FIG. 4, if the quantity of items in an order (or a potential order that is pending and has not yet been placed) exceeds a predetermined threshold (e.g., 25 items) the order quantity adder 424(4) may be included when determining the EDD. If the order (or a potential order) includes a bulky item (e.g., weight, one dimension, or total of all three dimensions exceeds a predetermined threshold) then the bulky item adder 424(2) may be included when determining the EDD.

At 810, zero or more regional holidays may be determined and taken into account (e.g., when determining the EDD). For example, in FIG. 4, the calendar management 412 may include regional holidays, including factory holidays in the factory calendar 414, corporate holidays in the corporate calendar 416, etc.

At 812, an estimated delivery date (EDD) associated with the product may be determined and provided, e.g., substantially in real time. For example, when the commitment engine 102 receives a message from one of the sales channel 110 indicating a potential order for a product, the commitment engine 102 may perform one or more of 802, 804, 806, 808, or 810 to determine, approximately in real time, the EDD for the product. The commitment engine 102 may provide the EDD to the corresponding sales channel 110 to enable the customer or sales person to select a product with an EDD that satisfies the customer's needs prior to the order being placed. After the order has been placed, the EDD may be determined and provided in response to a customer query. After the order has been placed, the commitment engine may automatically update the EDD (e.g., due to an unplanned event) and notify the customer of the updated EDD.

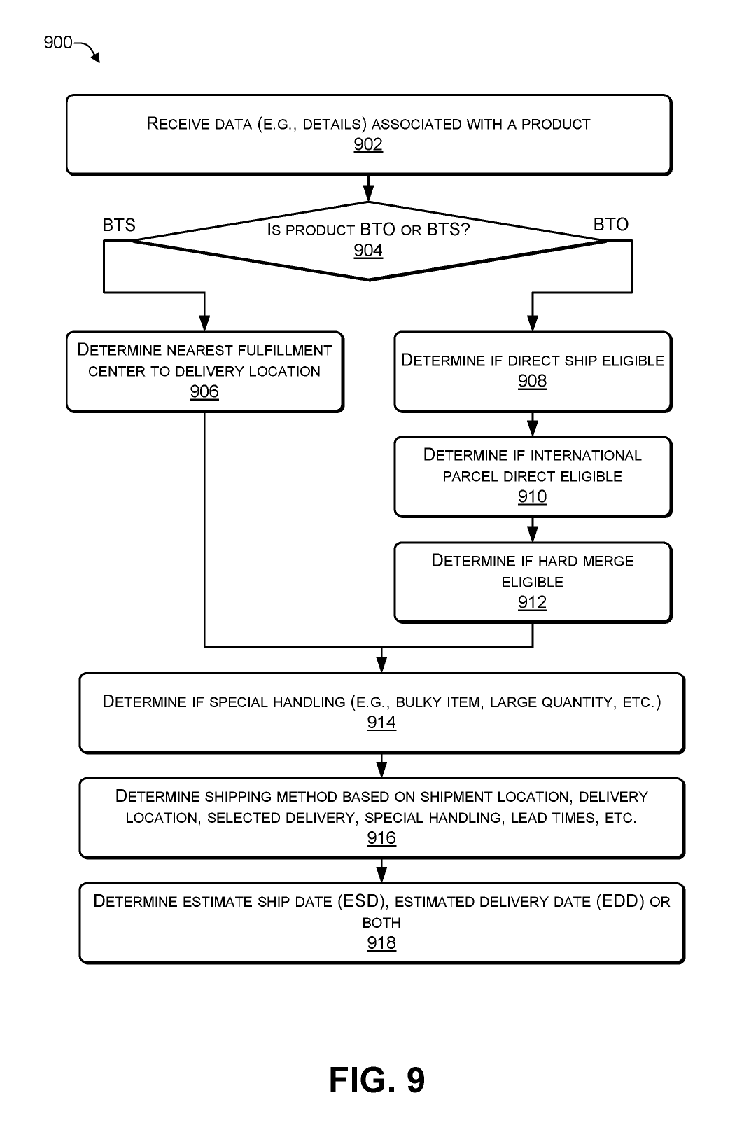

FIG. 9 is a flowchart of a process 900 that includes determining whether a product is built to order (BTO) or built to ship (BTS) according to some examples. For example, the process 900 may be performed by one or more components (e.g., the rules engine 410) of the commitment engine 102 of FIGS. 1-6.

At 902, details associated with a product (or an order) may be received. The details may be received when a customer or sales person is viewing the product online prior to placing an order. For example, in FIG. 1, the commitment engine 102 may receive product details, including a type of product that a customer desires to acquire, from a customer device via one of the sales channels 110. The details may be received after a customer or sales person has placed an order, e.g., when the customer or sales person requests an update on the ESD, EDD, or both. The details may be received when an unplanned event occurs and the commitment engine automatically updates the ESD, EDD, or both.

At 904, a determination may be made (e.g., based on the details) whether the product is a BTO product or a BTS product. In response to determining, at 904, that the product is a BTS product, a nearest fulfillment center (e.g., a nearest warehouse of the warehouses 202(1) to 202(M) of FIG. 2) to a delivery location associated with the product is determined, at 906, and the process proceeds to 914. In response to determining, at 904, that the product is a BTO product, a determination may be made at 908, whether the product is direct ship eligible, a determination may be made at 910, whether the product is international parcel direct ship eligible, and a determination may be made, at 912, whether the product is eligible for a hard merge. For a BTO product, the rules engine 410 of FIG. 4 may determine whether the BTO product is direct ship eligible, e.g., shipped from an ODM to a carrier hub and then to the delivery location (e.g., customer's postal code). For a BTO product, the rules engine 410 may determine whether the BTO product is eligible for international parcel direct, e.g., shipped from an ODM directly to the delivery location (e.g., customer's postal code, e.g., USPS zip code). For a BTO product, the rules engine 410 may determine whether the BTO product is eligible for a “hard merge” where the BTO product is shipped from the ODM to a fulfillment center (e.g., regional stocking warehouse) and then from the fulfillment center to the delivery location (e.g., customer's postal code, such as USPS zip code).

At 914, a determination may be made whether the special handling is to be used with the product. For example, an order that includes a bulky item, or in which the quantity of the products exceeds a threshold may require special handling because only freight companies may be capable of handling the order.

At 916, a shipping method may be selected based at least in part on the shipment location, the delivery location, the selected delivery (e.g., the type of delivery specified in the order, such as overnight delivery), the special handling, the lead times, and other factors discussed herein. For example, if the customer has selected and paid for overnight delivery, then overnight delivery may be selected.

At 918, an ESD, an EDD, or both may be provided. After the shipping method is selected, the commitment engine may provide the ESD, the EDD, or both to a customer or sales person.

Thus, a rules engine may include multiple rules to determine a shipping method based on the product (or order) details.

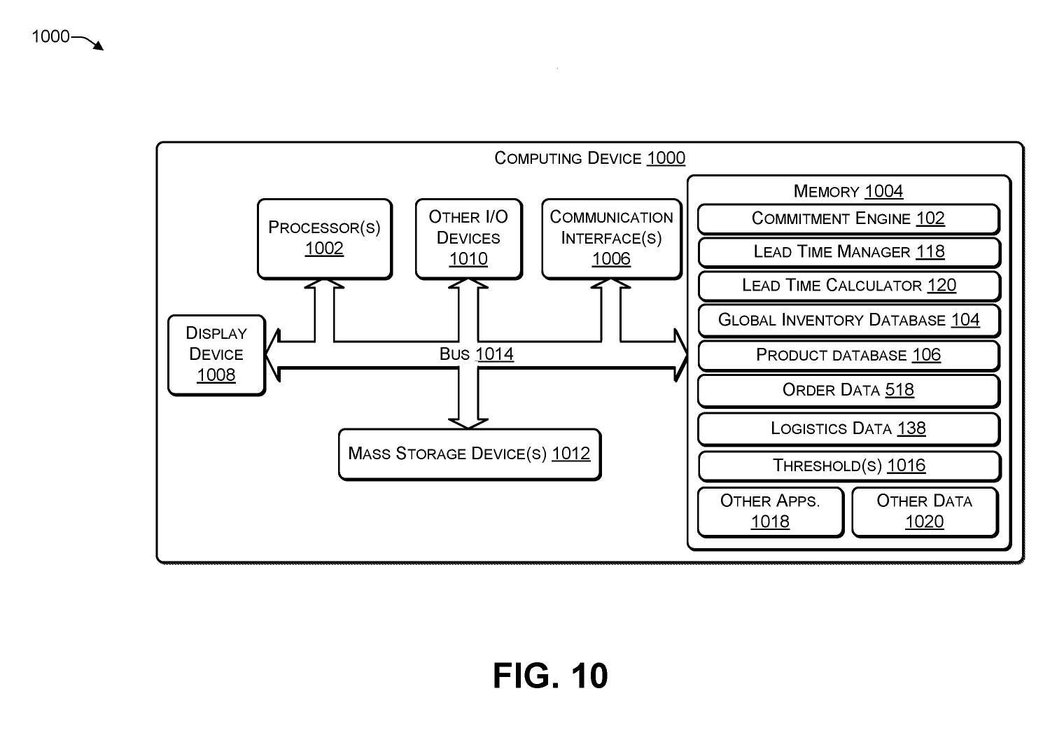

FIG. 10 illustrates an example configuration of a computing device 1000 that can be used to implement the systems and techniques described herein, such as the commitment engine 102 of FIG. 1. The computing device 1000 may include one or more processors 1002, a memory 1004, communication interfaces 1006, a display device 1008, other input/output (I/O) devices 1010, and one or more mass storage devices 1012, configured to communicate with each other, such as via a system bus 1014 or other suitable connection.

The processor 1002 is a hardware device (e.g., an integrated circuit) that may include one or more processing units, at least some of which may include single or multiple computing units or multiple cores. The processor 1002 can be implemented as one or more hardware devices, such as microprocessors, microcomputers, microcontrollers, digital signal processors, central processing units, state machines, logic circuitries, and/or any devices that manipulate signals based on executing operational instructions. Among other capabilities, the processor 1002 can be configured to fetch and execute computer-readable instructions stored in the memory 1004, mass storage devices 1012, or other computer-readable media.

Memory 1004 and mass storage devices 1012 are examples of computer storage media (e.g., memory storage devices) for storing instructions which are executed by the processor 1002 to perform the various functions described above. For example, memory 1004 may generally include both volatile memory and non-volatile memory (e.g., RAM, ROM, or the like) devices. Further, mass storage devices 1012 may include hard disk drives, solid-state drives, removable media, including external and removable drives, memory cards, flash memory, floppy disks, optical disks (e.g., CD, DVD), a storage array, a network attached storage, a storage area network, or the like. Both memory 1004 and mass storage devices 1012 may be collectively referred to as memory or computer storage media herein, and may be a media capable of storing computer-readable, processor-executable program instructions as computer program code that can be executed by the processor 1002 as a particular machine configured for carrying out the operations and functions described in the implementations herein.

The computing device 1000 may also include one or more communication interfaces 1006 for exchanging data (e.g., via a network). The communication interfaces 1006 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, cellular, satellite, etc.), the Internet, and the like. Communication interfaces 1006 can also provide communication with external storage (not shown), such as in a storage array, network attached storage, storage area network, or the like.

A display device 1008, such as a monitor may be included in some implementations for displaying information and images to users. Other I/O devices 1010 may be devices that receive various inputs from a user and provide various outputs to the user, and may include a keyboard, a remote controller, a mouse, a printer, audio input/output devices, and so forth.

The computer storage media, such as memory 1004 and mass storage devices 1012, may be used to store software and data. For example, the computer storage media may be used to store the commitment engine 102, the lead time manager 118, the lead time calculator 120, the global inventory database 104, the product database 106, the order data 518, one or more predetermined thresholds 1016, other applications 1018, and other data 1020. The predetermined threshold 1016 may include threshold to determine whether a product is to undergo special handling. For example, a product may be determined to undergo special handling (e.g., shipment via freight) based on determining that a sum of a height, a width, and a depth of the first product satisfies a pre-determined total dimensions threshold, determining that at least one of a height, a width, or a depth of the first product satisfies a pre-determined single dimension threshold, determining that a weight of the first product satisfies a pre-determined weight threshold, or determining that a quantity of products in an order satisfies a quantity threshold.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, and can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Software modules include one or more of applications, bytecode, computer programs, executable files, computer-executable instructions, program modules, code expressed as source code in a high-level programming language such as C, C++, C#, Perl, or other, a low-level programming code such as machine code, etc. An example software module is a basic input/output system (BIOS) file. A software module may include an application programming interface (API), a dynamic-link library (DLL) file, an executable (e.g., .exe) file, firmware, and so forth.

Processes described herein may be illustrated as a collection of blocks in a logical flow graph, which represent a sequence of operations that can be implemented in hardware, software, or a combination thereof. In the context of software, the blocks represent computer-executable instructions that are executable by one or more processors to perform the recited operations. The order in which the operations are described or depicted in the flow graph is not intended to be construed as a limitation. Also, one or more of the described blocks may be omitted without departing from the scope of the present disclosure.

Although various examples of the method and apparatus of the present disclosure have been illustrated herein in the Drawings and described in the Detailed Description, it will be understood that the disclosure is not limited to the examples disclosed, and is capable of numerous rearrangements, modifications and substitutions without departing from the scope of the present disclosure.

What is claimed is:

1. A computer-implemented method, comprising:
receiving, from a first customer computing device, first data associated with a first product;
determining, based at least in part on the first data, that the first product comprises a built-to-order product;
determining, based at least in part on the first data, a shipment type of the first product, the shipment type comprising one of:
a direct shipment comprising shipment from an original design manufacturer to a carrier hub and from the carrier hub to a delivery location;
an international parcel direct comprising shipment from the original design manufacturer directly to the delivery location; or
a hard merge shipment comprising shipment from the original design manufacturer to a regional fulfillment center and from the regional fulfillment center to the delivery location;
determining a first shipping method based at least in part on the first data and the shipment type;
determining, based at least in part on the first shipping method and weather data, at least one of a first estimated ship date or a first estimated delivery date;
sending, to the first customer computing device, a first message that includes at least one of the first estimated ship date or the first estimated delivery date.

2. The computer-implemented method of claim 1, wherein:
determining the first estimated ship date includes determining a manufacturing time to manufacture the first product at a manufacturing facility; and
determining the first estimated delivery date includes determining a shuttle time to transport the first product from the manufacturing facility to a fulfillment center.

3. The computer-implemented method of claim 2, wherein determining, based at least in part on the first data, that the first product is to undergo special handling comprises:
determining that a sum of a height, a width, and a depth of the first product satisfies a pre-determined total dimensions threshold.

4. The computer-implemented method of claim 2, wherein determining, based at least in part on the first data, that the first product is to undergo special handling comprises:
determining that at least one of a height, a width, or a depth of the first product satisfies a pre-determined single dimension threshold.

5. The computer-implemented method of claim 2, wherein determining, based at least in part on the first data, that the first product is to undergo special handling comprises:
determining that a weight of the first product satisfies a pre-determined weight threshold.

6. The computer-implemented method of claim 1, further comprising:
receiving, from a second customer computing device, second data associated with a second product;
determining, based at least in part on the second data, that the second product comprises a built-to-stock product;
determining a second delivery location included in the second data;
determining a nearest fulfillment center to the second delivery location;
determining a second shipping method based at least in part on the second data;
determining, based at least in part on the second shipping method, at least one of a second estimated ship date or a second estimated delivery date;
sending, to the second customer computing device, a second message that includes at least one of the second estimated ship date or the second estimated delivery date.

7. The computer-implemented method of claim 1, further comprising:
determining a logistics lead time associated with the first product;
determining a manufacturing lead time associated with the first product;
determining a payment lead time associated with the first product;
determining regional holidays associated with a region in which the original design manufacturer is located; and
determining planned events associated with the original design manufacturer.

8. One or more non-transitory computer-readable media storing instructions executable by one or more processors to perform operations comprising:
receiving, from a customer computing device, data associated with a product;
determining, based at least in part on the data, that the product comprises a built-to-order product;
determining, based at least in part on the first data, a shipment type of the product, the shipment type comprising one of:
a direct shipment comprising shipment from an original design manufacturer to a carrier hub and from the carrier hub to a delivery location;
an international parcel direct comprising shipment from the original design manufacturer directly to the delivery location; or
a hard merge shipment comprising shipment from the original design manufacturer to a regional fulfillment center and from the regional fulfillment center to the delivery location;
determining a shipping method based at least in part on the data and the shipment type;
determining, based at least in part on the shipping method and predicted weather data, at least one of an estimated ship date or an estimated delivery date;
sending, to the customer computing device, a message that includes at least one of the estimated ship date or the estimated delivery date.

9. The one or more non-transitory computer-readable media of claim 8, the operations further comprising:
determining a logistics lead time associated with the product.

10. The one or more non-transitory computer-readable media of claim 8, the operations further comprising:
determining a manufacturing lead time associated with the product including determining a manufacturing time to manufacture the product at a manufacturing facility and a shuttle time to shuttle the product from the manufacturing facility to a fulfillment center.

11. The one or more non-transitory computer-readable media of claim 8, the operations further comprising:
determining a payment lead time associated with the product.

12. The one or more non-transitory computer-readable media of claim 8, the operations further comprising:
determining regional holidays associated with a region in which the original design manufacturer is located.

13. The one or more non-transitory computer-readable media of claim 8, the operations further comprising:
determining planned events associated with the original design manufacturer.

14. A server, comprising:
one or more processors; and
one or more non-transitory computer-readable media storing instructions that are executable by the one or more processors to perform operations comprising:
receiving, from a first customer computing device, first data associated with a first product;
determining, based at least in part on the first data, that the first product comprises a built-to-order product;
determining, based at least in part on the first data, a shipment type of the first product, the shipment type comprising one of:
a direct shipment comprising shipment from an original design manufacturer to a carrier hub and from the carrier hub to a delivery location;
an international parcel direct comprising shipment from the original design manufacturer directly to the delivery location; or
a hard merge shipment comprising shipment from the original design manufacturer to a regional fulfillment center and from the regional fulfillment center to the delivery location;
determining a first shipping method based at least in part on the first data, weather data, and the shipment type;
determining, based at least in part on the first shipping method, at least one of a first estimated ship date or a first estimated delivery date;
sending, to the first customer computing device, a first message that includes at least one of the first estimated ship date or the first estimated delivery date.

15. The server of claim 14, the operations further comprising:
determining that the first product is to undergo special handling based on at least one of:
determining that a sum of a height, a width, and a depth of the first product satisfies a pre-determined total dimensions threshold;
determining that at least one of the height, the width, or the depth of the first product satisfies a pre-determined single dimension threshold; or
determining that a weight of the first product satisfies a pre-determined weight threshold.

16. The server of claim 14, the operations further comprising:
receiving, from a second customer computing device, second data associated with a second product;
determining, based at least in part on the second data, that the second product comprises a built-to-stock product;
determining a second delivery location included in the second data;
determining a nearest fulfillment center to the second delivery location;
determining a second shipping method based at least in part on the second data;
determining, based at least in part on the second shipping method, at least one of a second estimated ship date or a second estimated delivery date;
sending, to the second customer computing device, a second message that includes at least one of the second estimated ship date or the second estimated delivery date.

17. The server of claim 14, wherein the second message is sent less than thirty seconds after receiving the second data from the second customer computing device.

18. The server of claim 14, the operations further comprising:
determining a logistics lead time associated with the first product;
determining a manufacturing lead time associated with the first product including determining a manufacturing time to manufacture the first product at a manufacturing facility and a shuttle time to shuttle the first product from the manufacturing facility to a fulfillment center;
determining a payment lead time associated with the first product;
determining regional holidays associated with a region in which the original design manufacturer is located; and
determining planned events associated with the original design manufacturer.

19. The server of claim 14, the operations further comprising:
receiving notification of an unplanned event comprising a weather alert; and
automatically associating, based at least in part on the unplanned event, an unplanned events adder with the first product; and
determining a revised estimated ship date or a revised estimated delivery date associated with the first product based at least in part on the unplanned events adder.

20. The server of claim 14, the operations further comprising:
receiving an indication that the first product is to be discontinued; and
selling safety stock of the first product.
